(19) United States
(12) Patent Application Publication
(10) Pub. No.: US 2014/0327664 A1
(43) Pub. Date: Nov. 6, 2014

(54) IMAGE DISPLAY DEVICE AND METHOD OF CONTROLLING PIXEL CIRCUIT

(71) Applicant: SAMSUNG DISPLAY CO., LTD., YONGIN-CITY (KR)

(72) Inventors: Eiji KANDA, Yokohama (JP); Masayuki KUMETA, Yokohama (JP)

(73) Assignee: SAMSUNG DISPLAY CO., LTD., YONGIN-CITY (KR)

(21) Appl. No.: 14/265,830

(22) Filed: Apr. 30, 2014

(30) Foreign Application Priority Data
May 1, 2013 (JP) 2013-096233

(51) Int. Cl. G09G 3/32

(52) U.S. Cl. CPC G09G 3/3233
USPC 345/212; 345/76

(57) ABSTRACT

A pixel circuit includes a first transistor coupled to a light emitting element, a first capacitor coupled to the first transistor, a second transistor coupled to the first capacitor, a third transistor coupled between the second transistor and a data line; and a second capacitor having a first electrode coupled between the second and third transistors. The first transistor controls an amount of current supplied to the light emitting element based on a first data voltage while a second data voltage is stored in the second capacitor. The first data voltage is stored in the first capacitor.

### CROSS-REFERENCE TO RELATED APPLICATIONS

Japanese Patent Application No. 2013-096233, filed on May 1, 2013, and entitled, “Image Display Device and Method of Controlling Pixel Circuit,” is incorporated by reference herein in its entirety.

### BACKGROUND

1. Field

One or more embodiments described herein relate to a display device.

2. Description of the Related Art

Image display devices have been developed to include liquid crystals or organic light-emitting elements. These devices operation differently. For example, an image switching time of a display device having organic light-emitting elements is shorter than that of a display device made from liquid crystals. Also, the brightness (and thus clarity) of a display device having organic light-emitting elements is greater than that of a display device having liquid crystals.

Each pixel in a display device made with organic light-emitting elements has a transistor for controlling a driving operation for emitting light. An image having a spot (e.g., a partial brightness difference about the image) may be displayed if threshold voltages of driving transistors of pixels are different.

### SUMMARY

In accordance with one embodiment, a method is provide for controlling a pixel circuit which includes a first transistor to control an amount of current supplied to a light-emitting element corresponding to a voltage retained by a first capacitor connected to a gate electrode of the first transistor, a second transistor to control a connection between the gate electrode of the first transistor and a second capacitor and a connection between the first capacitor and second capacitor, and a third transistor to control a connection between the second capacitor and a data line. The method includes turning on the third transistor while current corresponding to a voltage stored in the first capacitor is supplied to the light-emitting element after the second transistor is turned off and turning on the second transistor after the third transistor is turned off.

The threshold voltage of the first transistor may be compensated with respect to a voltage stored in the first capacitor. The compensating may be performed before the second transistor is turned on after the third transistor is turned off. The method may include electrically disconnecting the light-emitting element from the first transistor after the third transistor is turned off.

In accordance with another embodiment, an image display device includes a control circuit including a first transistor configured to control an amount of current supplied to a light-emitting element based on a voltage stored in a first capacitor connected to a gate electrode of the first transistor; a second transistor configured to control a connection between the gate electrode of the first transistor and the first capacitor and a connection between the gate electrode of the first transistor and the second capacitor; and a third transistor configured to control a connection between the second capacitor and a data line, wherein the third transistor is turned on while a current corresponding to the voltage stored in the first capacitor is supplied to the light-emitting element after the second transistor is turned off, and the second transistor is turned on after the third transistor is turned off.

The third transistor may be turned off after a threshold voltage of the first transistor is compensated with respect to the voltage stored in the first capacitor, and the second transistor may be turned on after the third transistor is turned off.

In accordance with another embodiment, a pixel circuit includes a first transistor coupled to a light emitting element; a first capacitor coupled to the first transistor; a second transistor coupled to the first capacitor; and a third transistor coupled between the second transistor and a data line; and a second capacitor having a first electrode coupled between the second and third transistors, wherein the first transistor controls an amount of current supplied to the light emitting element based on a first data voltage while a second data voltage is stored in the second capacitor, and wherein the first data voltage is stored in the first capacitor.

The first data voltage may correspond to a first frame of image data, and the second data voltage may correspond to a second frame of image data. The first data voltage may be stored in the second capacitor before the second data voltage is stored in the second capacitor. The first data voltage may be transferred from the data line for storage in the second capacitor when the third transistor is on and the second transistor is off.

The first data voltage may be transferred from the second capacitor for storage in the first capacitor when the third transistor is off and the second transistor is on. The second data voltage may be transferred from the data line to the second capacitor when the third transistor is on, the second transistor is off, and the first data voltage is stored in the first capacitor.

The first capacitor may be coupled between two terminals of the first transistor. The second capacitor may have a second electrode coupled to a power supply voltage. The third transistor may be controlled by a scan signal. The first capacitor may store a voltage based on an initialization voltage before the first data voltage is stored in the first capacitor.

The circuit may include a third capacitor having a first electrode coupled to the first transistor and first capacitor and a second electrode coupled between the first transistor and a power supply voltage. The third capacitor may store a voltage based on a threshold voltage of the first transistor before the first data voltage is stored in the first capacitor.

In accordance with another embodiment, a pixel may include a light emitting element; and a control circuit to control the light emitting element, wherein the light emitting element emits light based on a first data voltage while simultaneously storing a second data voltage, and wherein the first data voltage corresponds to a first frame of image data and the second data voltage corresponds to a second frame of image data.

The control circuit may include a first transistor coupled to the light emitting element; a first capacitor coupled to the first transistor; a second transistor coupled to the first capacitor; and a third transistor coupled between the second transistor and a data line; and a second capacitor having a first electrode coupled between the second and third transistors, wherein the first transistor controls an amount of current supplied to the light emitting element based on the first data voltage while the second data voltage is stored in the second capacitor.

The first data voltage may be stored in the second capacitor before the second data voltage is stored in the second capacitor. The first data voltage may be transferred from the data line for storage in the second capacitor when the third transistor is on and the second transistor is off. The first data voltage may be transferred from the second capacitor for storage in the first capacitor when the third transistor is off and the second transistor is on. The third transistor may be controlled by a scan signal.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an embodiment of a pixel circuit;

FIG. 3A illustrates an embodiment of control signals for a pixel circuit, FIG. 3B illustrates a timing diagram for displaying a two-dimensional image; and FIG. 3C illustrates a timing diagram for displaying a three-dimensional image;

FIG. 4 illustrates operation of a pixel circuit during a threshold voltage compensation period according to one embodiment;

FIG. 5 illustrates operation of a pixel circuit during a transfer period according to one embodiment;

FIG. 6 illustrates operation of a pixel circuit during an emission period according to one embodiment;

FIG. 7 illustrates another embodiment of a pixel circuit;

FIG. 8 illustrates control signals for a pixel circuit according to another embodiment; and

FIG. 9 illustrates another embodiment of a pixel circuit.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

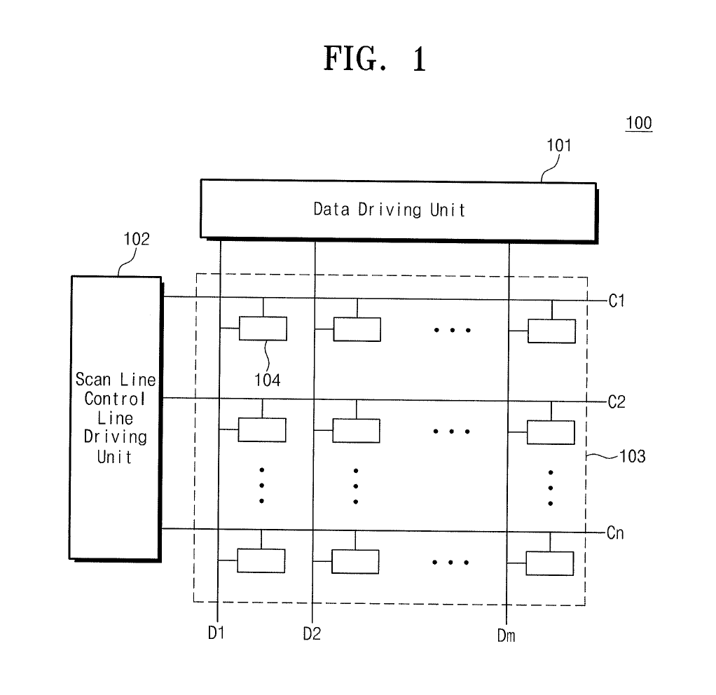

FIG. 1 illustrates an embodiment of an image display device 100 which includes a data driving unit 101, a scan line control signal driving unit 102, and a plurality of pixels 104. The data driving unit 101 supplies data signals to a plurality of data lines D1 to Dm. The scan line control signal driving unit 102 supplies signals to control signal lines C1 to Cn, which include a plurality of scan lines. The pixels 104 are disposed at intersections of data lines D1 to Dm and control signal lines C1 to Cn.

The pixels 104 may be disposed in a line shape (e.g., rows and columns) with respect to the data lines and control signal lines. The pixels are disposed in an area 103, including intersections of the data lines D1 to Dm and control signal lines C1 to Cn to form a matrix shape.

Each of the pixels 104 receives brightness information corresponding to a data signal supplied to a respective one of the data lines D1 to Dm. The timing of when brightness information in a data signal supplied to a data line is written at any one pixel, and the timing of when any one pixel emits light based on the brightness information, may be controlled by a corresponding one of the control signal lines C1 to Cn in one group. In one embodiment, to be described in greater detail below, brightness information for the pixels 104 is programmed while one or more of the pixels 104 emit light, which has the effect of increasing an emission period.

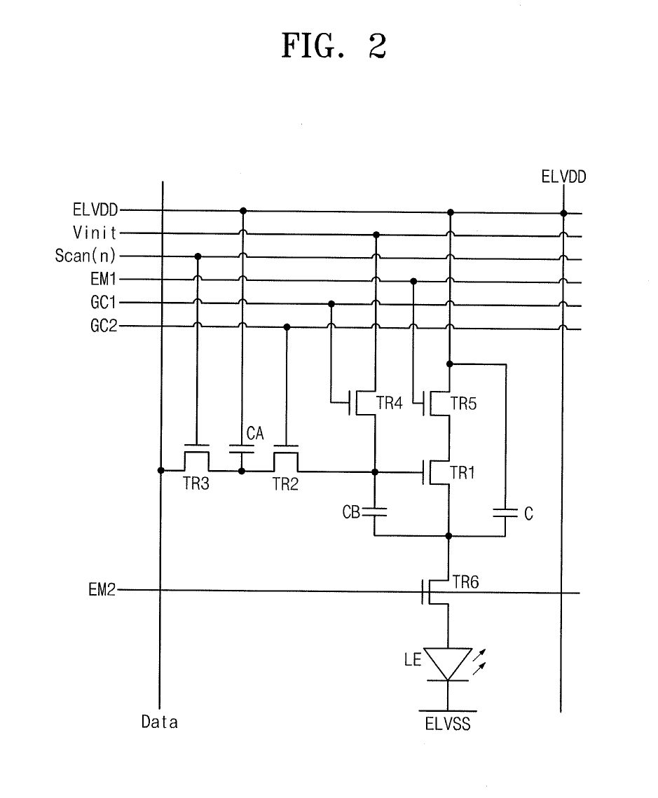

FIG. 2 illustrates an embodiment of a pixel circuit, which, for example, may correspond to the pixels in FIG. 1. In FIG. 2, a first voltage ELVDD is supplied to a control signal line, which is connected to transistor TR1 (first transistor) via transistor TR5 (fifth transistor). For example, the first voltage ELVDD is supplied to a first electrode of the fifth transistor TR5. A second electrode of the fifth transistor TR5 is connected to a first electrode of the first transistor TR1.

A capacitor CB (first capacitor) is connected between a gate electrode and a second electrode of the first transistor TR1. The first capacitor CB stores a voltage that is supplied between the gate electrode and second electrode of the first transistor TR1. The fifth transistor TR5 is turned on when a control signal EM1 (first control signal) applied to a corresponding one of the control signal lines has a high level H. When the first voltage ELVDD is supplied to the first electrode of first transistor TR1, the amount of current flowing to the second electrode of first transistor TR1 from the first electrode thereof may be adjusted according to a voltage stored in the first capacitor CB. A voltage for turning off the fifth transistor TR5 may be a low level L. Voltages (or, signals) applied to gate electrodes of other transistors may be designated by a high level H and a low level L.

As a transistor TR6 (sixth transistor) is turned on in response to a low-to-high transition of a control signal EM2 (second control signal) applied to one of the control signal lines, a light-emitting element LE and second electrode of first transistor TR1 are electrically connected. At this time, the amount of current flowing to the light-emitting element LE is controlled according to the voltage stored in the first capacitor CB.

A first electrode of transistor TR6 is connected to the second electrode of first transistor TR1. A second electrode of transistor TR6 is connected to a first electrode of light-emitting element LE. A second electrode of light-emitting element LE is connected to a second voltage ELVSS. The light-emitting element LE may include an organic light-emitting diode. In this case, the first electrode of light-emitting element LE may be an anode and the second electrode may be a cathode.

A first electrode of a capacitor CA (second capacitor) is connected to the first voltage ELVDD. A second electrode of capacitor CA is connected to a first electrode of a transistor TR2 (second transistor) and a second electrode of a transistor TR3 (third transistor).

A second electrode of second transistor TR2 is connected to the gate electrode of first transistor TR1 and the first electrode of first capacitor CB. Also, a gate electrode of second transistor TR2 is connected to a signal line, to which a control signal GC2 (third control signal) is applied. The second transistor TR2 is turned on when the third control signal GC2 has a high level. Thus, a voltage stored by second capacitor CA is transferred to first capacitor CB. A voltage stored in second capacitor CA includes information for the pixel. As a voltage is provided from second capacitor CA to first capacitor CB, information associated therewith is also transferred. The first capacitor CB may retain information corresponding to a transferred voltage.

A first electrode of third transistor TR3 is connected to a data line. The second electrode of third transistor TR3 is connected to the second electrode of second capacitor CA. A scan signal Scan(n) is provided to a signal line connected to a gate electrode of third transistor TR3. The third transistor TR3 is turned on when scan signal Scan(n) has a high level H. Therefore, second capacitor CA receives a voltage (data voltage) corresponding to a data signal to be supplied to the data line. That is, information of a data voltage supplied to the data line Data is programmed in second capacitor CA. Also, “n” of the scan signal Scan(n) means that n pixels are connected to a data line Data and that at least scan signals Scan(1) to Scan(n) exist.

A level of scan signal Scan(n) and a level of third control signal GC2 are controlled so that second transistor TR2 is turned off when third transistor TR3 is turned on. With this condition, second capacitor CA and first capacitor CB are not connected while a data voltage is supplied to the second capacitor CA from the data line. Thus, the amount of current flowing between the first electrode and second electrode of first transistor TR1 is controlled by a voltage stored in first capacitor CB, while a data voltage is supplied to the second capacitor CA from the data line Data.

The first and second control signals EM1 and EM2 are controlled so that fifth and sixth transistors TR5 and TR6 are turned on while the amount of current flowing between the first and second electrodes of first transistor TR1 is controlled. The amount of light emission from light-emitting element LE may be controlled according to the above-described condition. Thus, it is possible to perform an operation of supplying a data voltage from the data line Data to the second capacitor CA at the same time as light-emitting element LE emits light.

In the present embodiment, the level of scan signal Scan(n) and the level of third control signal GC2 are controlled so that second transistor TR2 is turned on when the third transistor TR3 is turned off. With this condition, information indicative of a voltage stored in second capacitor CA is provided to first capacitor CB, and a voltage indicating such information is stored in first capacitor CB.

Also, compensation on a threshold voltage of the first transistor TR1 is performed by controlling a level of scan signal Scan(n) and a level of third control signal GC2, so that second transistor TR2 is turned off when third transistor TR3 is turned off.

Referring to FIG. 2, a gate electrode of a transistor TR4 (fourth transistor) is connected to a signal line to which a fourth control signal GC1 is applied. A first electrode of transistor TR4 is connected to a signal line to which an initialization voltage Vinit is applied. A second electrode of transistor TR4 is connected to the second electrode of second transistor TR2, first electrode of first capacitor CB, and gate electrode of first transistor TR1. A gate electrode of fifth transistor TR5 is connected to a signal line to which the first control signal EM1 is applied A capacitor C (third capacitor) is connected between a first electrode of fifth transistor TR5 and the first electrode of first transistor TR1.

A level of scan signal Scan(n) and a level of third control signal GC2 are controlled so that second transistor TR2 is turned off when third transistor TR3 is turned off. Also, the fourth control signal GC1 and first control signal EM1 are controlled so that fourth and fifth transistors TR4 and TR5 are turned on. When this occurs, the initialization voltage Vinit is provided to the first electrode of first capacitor CB and a voltage of (Vinit−Vth) (Vth is a threshold voltage of first transistor TR1) is applied to the second electrode of first capacitor CB. With this condition, compensation on a threshold voltage of first transistor TR1 is performed. In other words, the threshold voltage of first transistor TR1 is stored in first capacitor CB.

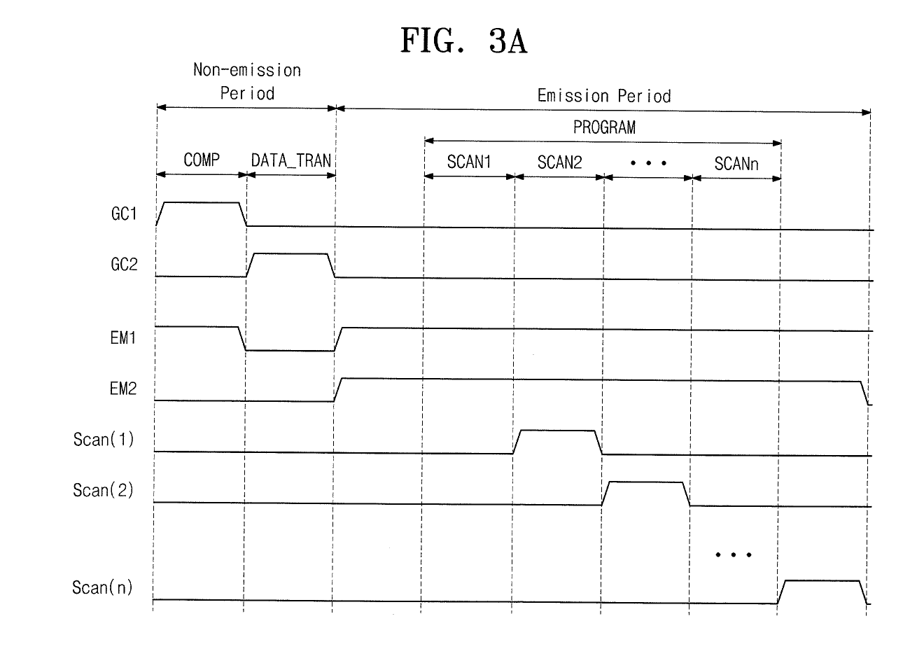

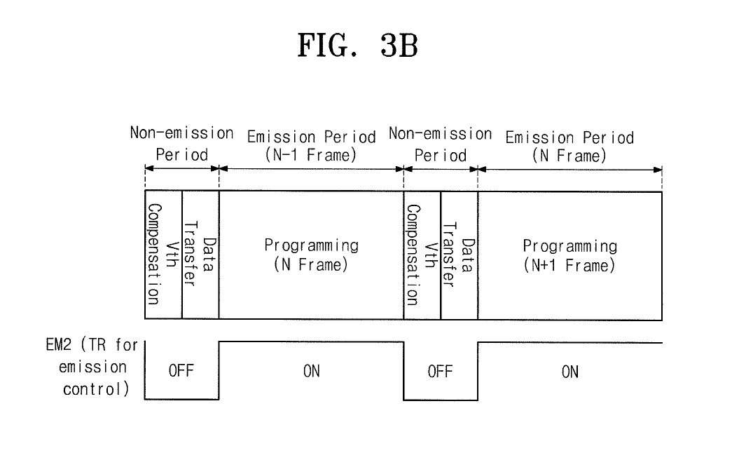

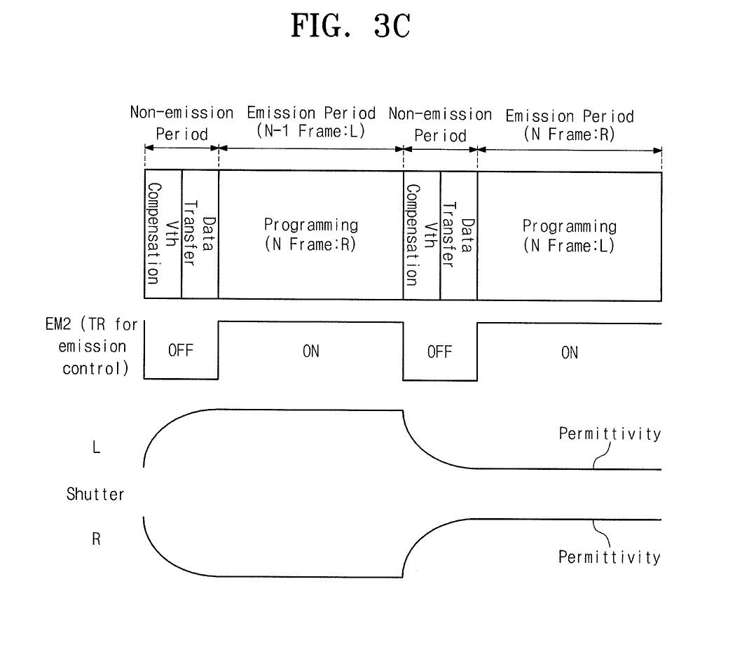

FIG. 3A illustrates an embodiment of a timing diagram including control signals for a pixel circuit, which, for example, may be the pixel circuit in FIG. 1. As illustrated in FIG. 3A, the timing of control signals supplied to the pixel circuit is divided into a non-emission period and an emission period. The non-emission period is divided into a threshold voltage compensation period COMP and a transfer period DATA_TRAN. The emission period is divided into program periods PROGRAM of second capacitors of pixel circuits connected to the same data line. In one embodiment, all light-emitting elements may emit light during respective emission periods, that is, during the same period as the emission period.

During the non-emission period, sixth transistor TR6 and third transistor TR3 are turned off based on the low level L of second control signal EM2 and scan signal Scan(n). With this condition, light-emitting element LE does not emit light. Also, second capacitor CA is electrically disconnected from a data line Data.

During the threshold voltage compensation period COMP, fourth transistor TR4 is turned on in response to a high level of fourth control signal GC1. At this time, initialization voltage Vinit is applied to the second electrode of second transistor TR2, the first electrode of first capacitor CB, and the gate electrode of first transistor TR1. Also, second transistor TR2 is turned off in response to a low level L of third control signal GC2. Therefore, first and second capacitors CB and CA are electrically disconnected. Also, threshold voltage compensation is performed when a fifth transistor TR5 is turned on in response to a high level H of a first control signal EM1.

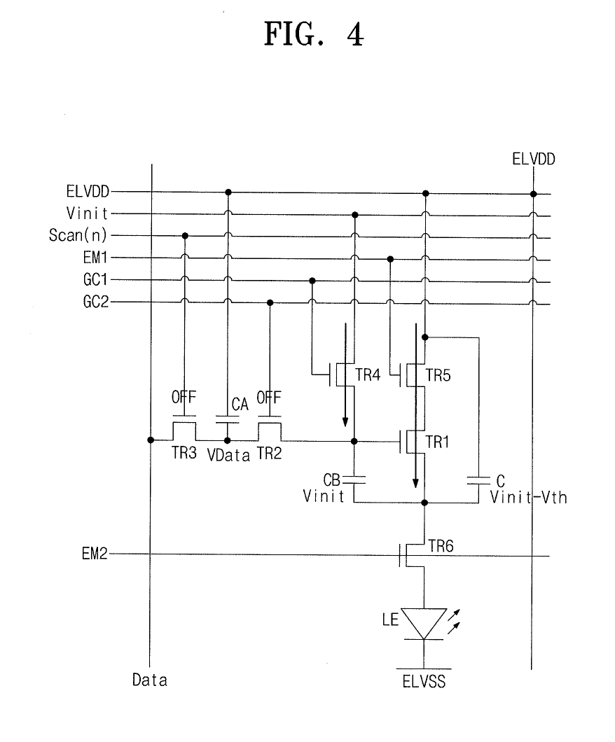

FIG. 4 illustrates operation of the pixel circuit during threshold voltage compensation period COMP according to one embodiment. Second, third, and sixth transistors TR2, TR3, and TR6 are turned off, and fourth and fifth transistors TR4 and TR5 are turned on. With this condition, light-emitting element LE does not emit light, an initialization voltage Vinit is applied to the first electrode of first capacitor CB, and a voltage of (Vinit−Vth) (Vth is a threshold voltage of first transistor TR1) is applied to the second electrode of first capacitor CB.

During a transfer period DATA_TRAN, fourth transistor TR4 is turned off in response to a low level L of fourth control signal GC1. As a result, supply of initialization voltage Vinit to the gate electrode of first transistor TR1 is stopped, the first electrode of first capacitor CB, and second electrode of second transistor TR2. Also, because third control signal GC2 is set to a high level H and first control signal EM1 is set to a low level L, a voltage stored in second capacitor CA is transferred to first capacitor CB and data programmed in second capacitor CA is sent to first capacitor CB.

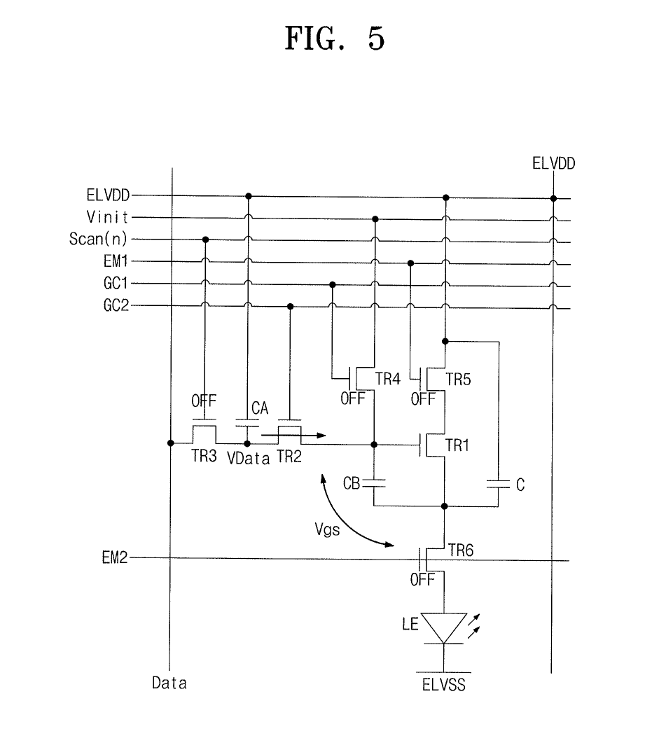

FIG. 5 illustrates an example of transfer period DATA_TRAN. In this period, third, fourth, fifth, and sixth transistors TR3, TR4, TR5, and TR6 are turned off and a second transistor TR2 is turned on. As a result, light-emitting element LE does not emit light and data programmed in second capacitor CA is transferred to first capacitor CB.

In FIG. 5, a voltage Vgs that first capacitor CB stores may be expressed as: (α Vdata−α Vinit+Vth), where Vdata is a data voltage programmed in second capacitor CA. Also, in this expression, α is CA C/(CA CB+CB C+C CA), where CA, CB, and C correspond to the capacitance of capacitor CA, the capacitance of capacitor CB, and capacitance of third capacitor C. Thus, voltage Vgs stored in first capacitor CB reflects a voltage corresponding to a data signal. The light-emitting element LE therefore emits light with brightness based on the data voltage. Also, because voltage Vgs stored in first capacitor CB includes the threshold voltage Vth of first transistor TR1, a Vth-compensated voltage is retained.

During the emission period, third and fourth control signals GC1 and GC2 have a low level L and second and fourth transistors TR2 and TR4 are turned off. Also, fifth and sixth transistors TR5 and TR6 are turned on in response to high levels H of first and second control signals EM1 and EM2. With this condition, current corresponding to a voltage stored in first capacitor CB flows into light-emitting element LE.

Also, scan signal Scan(n) has a high level H based on the position of the pixel. For example, a voltage applied to n scan lines has a high level H, third transistor TR3 is turned on, and second capacitor CA is connected to the data line. Thus, second capacitor CA is programmed.

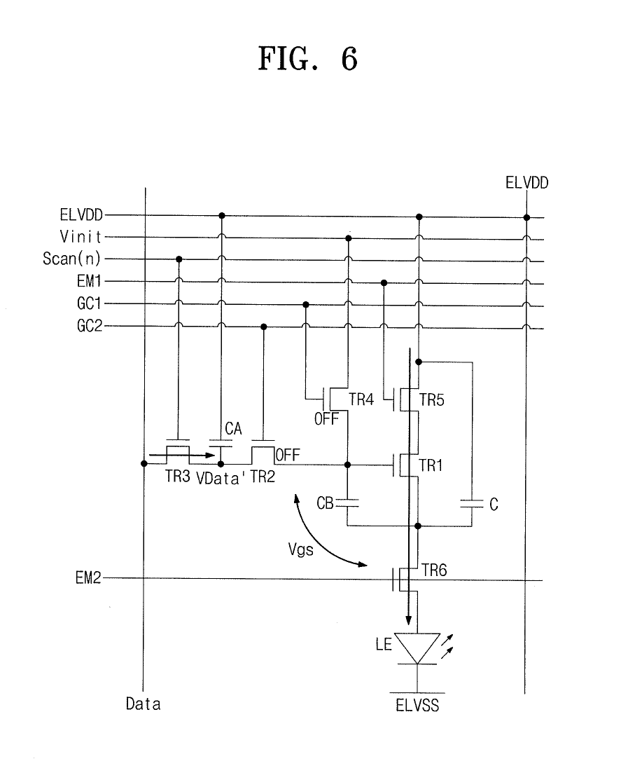

FIG. 6 illustrates an example of an emission period in which second and fourth transistors TR2 and TR4 are turned off and fifth and sixth transistors TR5 and TR6 are turned on, light-emitting element LE emits light and second capacitor CA is programmed at timing when scan signal Scan(n) has a high level H. Also, in accordance with one embodiment, initialization voltage Vinit is supplied to the first electrode of fourth transistor TR4 from a control signal line. In another embodiment, initialization voltage Vinit may be supplied from data line Data. Alternatively, a first voltage ELVDD may be supplied to the first electrode of fourth transistor TR4, instead of the initialization voltage Vinit.

Also, the power supply voltage may vary when a fourth control signal GC1 and a first control signal EM1 have a high level H in all pixel circuits during a threshold voltage compensation period COMP. For this reason, pixel circuits may be divided into blocks, such that compensation of threshold voltages is performed at different timings.

FIG. 3B illustrates a timing diagram for the image display device according to another embodiment for displaying a two-dimensional image. In this embodiment, threshold voltage compensation period (Vth compensation) exists before an emission period in which an image of an N−1st frame is displayed. The transfer period (data transfer) exists between the threshold voltage compensation period and emission period. Also, during the emission period in which an image of an N−1st frame is displayed, a data signal for displaying an image of an Nth frame is programmed at the same time of displaying of an image of the N−1st frame.

Also, the threshold voltage compensation period exists before an emission period in which an image of an Nth frame is displayed. The transfer period exists between the threshold voltage compensation period and emission period. Also, during a transfer period of the Nth frame, a data signal programmed during the emission period in which an image of the N−1st frame is displayed is transferred.

Thus, light emitting is performed during a remaining period e.g., other than the threshold voltage compensation period and transfer period. Also, second control signal EM2 (a switching signal of a transistor for control light emission) controls sixth transistor TR6 to turn off during a period other than the threshold voltage compensation period and transfer period, and is turned on during the emission period.

FIG. 3C illustrates a timing diagram for the image display device according to another embodiment for displaying a three-dimensional image. In this embodiment, a left-eye image is displayed during an N−1st frame and a right-eye image is displayed during an Nth frame, e.g., a three-dimensional image. This timing diagram also includes additional timing control compared with FIG. 3B. In FIG. 3C, L indicates permittivity of a left-eye shutter and R indicates permittivity of a right-eye shutter.

Permittivity of the left-eye shutter and right-eye shutter may be changed in a threshold voltage compensation period and a transfer period. As illustrated in FIG. 3C, programming may be performed in parallel during an emission period, which makes it possible to elongate the emission period and reduce brightness of light emission. Thus, the lifetime of the light-emitting element may be extended.

In one embodiment, a signal supplied to a data line includes information which is programmed in each pixel during emission of a light-emitting element. Also, it is possible to compensate for a threshold voltage.

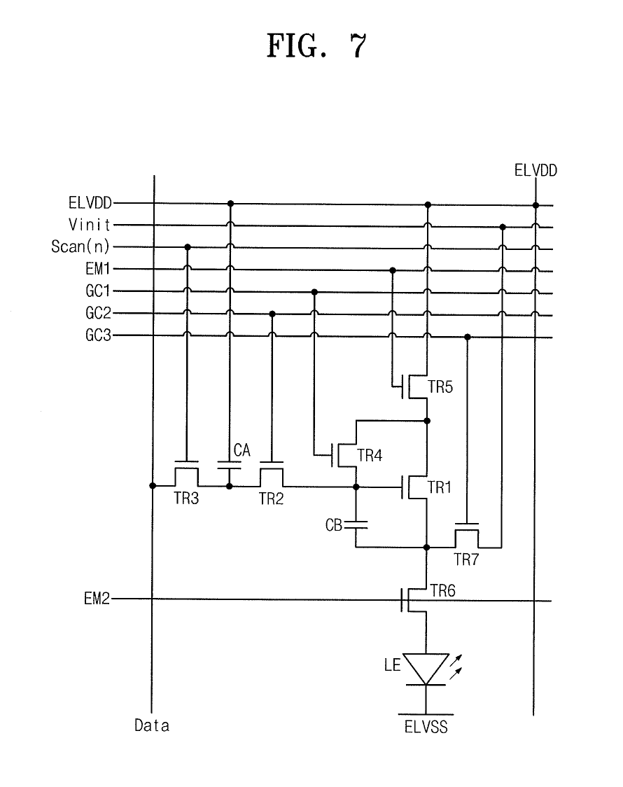

FIG. 7 illustrates another embodiment of a pixel circuit. In this embodiment, first voltage ELVDD is supplied to a signal line connected to first transistor TR1, via fifth transistor TR5. That is, first voltage ELVDD is supplied to a first electrode of fifth transistor TR5. A second electrode of fifth transistor TR5 is connected to the first electrode of first transistor TR1.

A first capacitor CB is connected between a gate electrode and second electrode of first transistor TR1. A voltage stored in first capacitor CB retains is supplied between the gate electrode and second electrode of first transistor TR1. The fifth transistor TR5 is turned on when first control signal EM1 has a high level H. If first voltage ELVDD is supplied to the first electrode of first transistor TR1, the amount of current flowing to the second electrode of first transistor TR1 from the first electrode thereof may be adjusted according to the voltage stored in first capacitor CB.

As sixth transistor TR6 is turned on in response to a low-to-high transition of second control signal EM2, current flowing to light-emitting element LE is controlled by a voltage stored in first capacitor CB. Here, a first electrode of sixth transistor TR6 is connected to the second electrode of first transistor TR1. A second electrode of sixth transistor TR6 is connected to the first electrode of light-emitting element LE. The second electrode of light-emitting element LE is connected to receive a second voltage ELVSS. The light-emitting element LE includes an organic light-emitting diode. In this case, the first electrode of light-emitting element LE is an anode and the second electrode is a cathode.

Also, a first electrode of second capacitor CA is connected to receive first voltage ELVDD. A second electrode of second capacitor CA is connected to a first electrode of second transistor TR2 and a second electrode of third transistor TR3.

A second electrode of second transistor TR2 is connected to the gate electrode of first transistor TR1 and first electrode of first capacitor CB. Also, a gate electrode of second transistor TR2 is connected to receive a third control signal GC2. The second transistor TR2 is turned on when third control signal GC2 has a high level. Thus, the voltage stored in second capacitor CA is transferred to first capacitor CB. The voltage stored in second capacitor CA includes information corresponding thereto. As the voltage is provided from second capacitor CA to first capacitor CB, information associated therewith is also transferred. The first capacitor CB may store information corresponding to the transferred voltage.

Also, the first electrode of third transistor TR3 is connected to a data line. The second electrode of third transistor TR3 is connected to the second electrode of second capacitor CA as described above. Scan signal Scan(n) is provided to a signal line connected to the gate electrode of third transistor TR3. The third transistor TR3 is turned on when scan signal Scan(n) has a high level H. Therefore, second capacitor CA receives a voltage (i.e., a data voltage) corresponding to a data signal to be supplied to the data line. That is, information of a data voltage supplied to data line Data is programmed in second capacitor CA. (The notation n of scan signal Scan(n) means that at least n pixels are connected to a data line Data, and that at least scan signals Scan(1) to Scan(n) exist).

The level of scan signal Scan(n) and the level of third control signal GC2 are controlled so that second transistor TR2 is turned off when third transistor TR3 is turned on. With this condition, second capacitor CA and first capacitor CB are not connected while a data voltage is supplied to second capacitor CA from the data line. Thus, the amount of current flowing between the first electrode and second electrode of first transistor TR1 is controlled by a voltage stored in first capacitor CB, while a data voltage is supplied to second capacitor CA from data line Data.

The first and second control signals EM1 and EM2 are controlled so that fifth and sixth transistors TR5 and TR6 are turned on while the amount of current flowing between the first and second electrodes of first transistor TR1 is controlled. The amount of light emission of light-emitting element LE may be controlled according to the above-described condition.

Thus, in accordance with this embodiment, it is possible to supply a data voltage from data line Data to second capacitor CA at the same time light-emitting element LE is emitting light.

Also, the level of scan signal Scan(n) and the level of third control signal GC2 are controlled so that second transistor TR2 is turned on when third transistor TR3 is turned off. With this condition, information indicative of the voltage stored in second capacitor CA is provided to first capacitor CB, and a voltage indicating such information is stored in first capacitor CB.

Also, compensation of the threshold voltage of first transistor TR1 is performed by controlling the level of scan signal Scan(n) and the level of third control signal GC2, so that second transistor TR2 is turned off when third transistor TR3 is turned off.

Referring to FIG. 7, the gate electrode of fourth transistor TR4 is connected to a signal line, to which a fourth control signal GC1 is applied. A first electrode of transistor TR4 is connected to a second electrode of fifth transistor TR5 and the first electrode of first transistor TR1. A second electrode of transistor TR4 is connected to the second electrode of second transistor TR2, the first electrode of first capacitor CB, and the gate electrode of first transistor TR1.

Also, the gate electrode of fifth transistor TR5 is connected to a signal line, to which the first control signal EM1 is applied. The gate electrode of transistor TR7 (seventh transistor) is connected to a signal line to which a control signal GC3 (fifth control signal) is applied. The first electrode of transistor TR7 is connected to a signal line to which initialization voltage Vinit is applied. The second electrode of transistor TR7 is connected to the second electrode of first transistor TR1, the second electrode of first capacitor CB, and the first electrode of sixth transistor TR6.

The level of scan signal Scan(n) and the level of third control signal GC2 are controlled so that second transistor TR2 is turned off when third transistor TR3 is turned off. Also, the first control signal EM1, fourth control signal GC1, and fifth control signal GC3 are controlled so that fifth transistor TR5 is turned off and fourth and seventh transistors TR4 and TR7 are turned on. In this case, initialization voltage Vinit is provided to the second electrode of first capacitor CB, and a voltage of (Vinit−Vth) is applied to the first electrode of first capacitor CB.

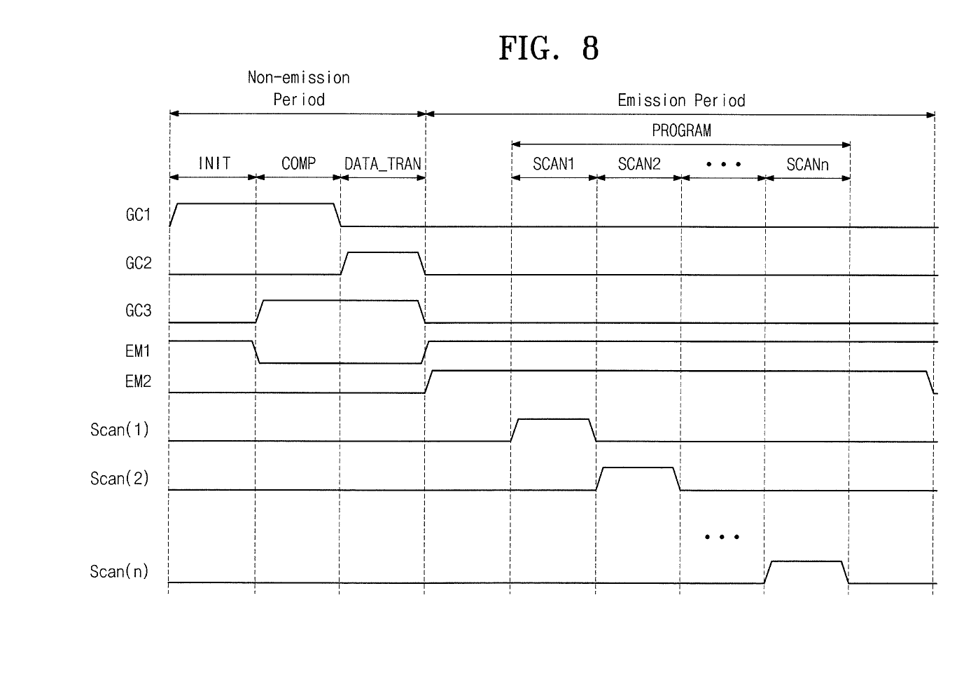

FIG. 8 illustrates a timing diagram for the pixel circuit in FIG. 7 according to one embodiment. As illustrated in FIG. 8, the timing of control signals supplied to the pixel circuit is divided into a non-emission period and an emission period. The non-emission period is divided into an initialization period INIT, a threshold voltage compensation period COMP and a transfer period DATA_TRAN. The emission period is divided into program periods PROGRAM of second capacitors of pixel circuits connected to the same data line. In one embodiment, all light-emitting elements of the image display device may emit light during respective emission periods, that is, during the same period as the emission period.

During initialization period INIT, fourth control signal GC1 and first control signal EM1 are set to a high level H and signals applied to other control signal lines are set to a low level L, fourth and fifth transistors TR4 and TR5 are turned on, and other transistors are turned off. A first voltage ELVDD is applied to a first electrode of first capacitor CB, and a voltage that first capacitor CB stores is reset.

During threshold voltage compensation period COMP, seventh transistor TR7 is turned on in response to a high level of fifth control signal GC3, and initialization voltage Vinit is applied to the second electrode of first capacitor CB. Also, fifth transistor TR5 is turned off in response to a low level L of first control signal EM1. During initialization period INIT, first voltage ELVDD is applied to the first electrode first capacitor CB, so first transistor TR1 is turned on. At this time, because the first electrode of first capacitor CB is electrically connected to a signal line to which initialization voltage Vinit is applied, a voltage supplied to the first electrode of first capacitor CB is higher by threshold voltage Vth than that supplied to the second electrode thereof. In this case, compensation on a threshold voltage is performed.

During transfer period DATA_TRAN, fourth transistor TR4 is turned off in response to a low level L of fourth control signal GC1. Therefore, supply of initialization voltage Vinit to the first electrode of first capacitor CB is stopped. Also, second transistor TR2 is turned on when third control signal GC2 is set to a high level H. Thus, the voltage stored in second capacitor CA is transferred to first capacitor CB, and data programmed in the second capacitor CA is sent to the first capacitor CB.

With the above description, a potential difference Vgs between the first electrode and second electrode of first capacitor CB may be expressed by (CA VData+CB (Vinit+Vth))/(CA+CB). Here, Vdata is a data voltage programmed in the second capacitor CA. Also, CA and CB indicate capacitance of first capacitor CB and capacitance of second capacitor CA.

Thus, the potential difference Vgs between the first electrode and second electrode of first capacitor CB reflects a data voltage, and light-emitting element LE emits light with brightness according to the data voltage. Also, because the potential difference Vgs between the first electrode and second electrode of first capacitor CB includes threshold voltage Vth of first transistor TR1, compensation on a threshold voltage is performed.

In the emission period, because third and fourth control signals GC1 and GC2 have a low level L, second and fourth transistors TR2 and TR4 are turned off. The fifth and sixth transistors TR5 and TR6 are turned on in response to high levels H of the first and second control signals EM1 and EM2.

With the above description, current corresponding to the voltage stored in first capacitor CB flows into light-emitting element LE. Also, because scan signal Scan(n) has a high level H according to the position of the pixel, (e.g., a voltage applied to n scan lines has a high level H), third transistor TR3 is turned on and second capacitor CA is connected to a data line. Thus, the second capacitor CA is programmed.

In one embodiment, initialization voltage Vinit is supplied to the first electrode of seventh transistor TR7. In an alternative embodiment, initialization voltage Vinit may be supplied from a data line Data.

Also, a power supply voltage may vary when fourth control signal GC1, first control signal EM1, and fifth control signal GC3 have a high level H in all pixel circuits during the initialization period INT and threshold voltage compensation period COMP. For this reason, pixel circuits may be divided into blocks such that compensation on threshold voltages is performed at different timings.

In one embodiment, information indicating a signal supplied to a data line is programmed in each pixel while the light-emitting element emits light. Also, it is possible to compensate for a threshold voltage.

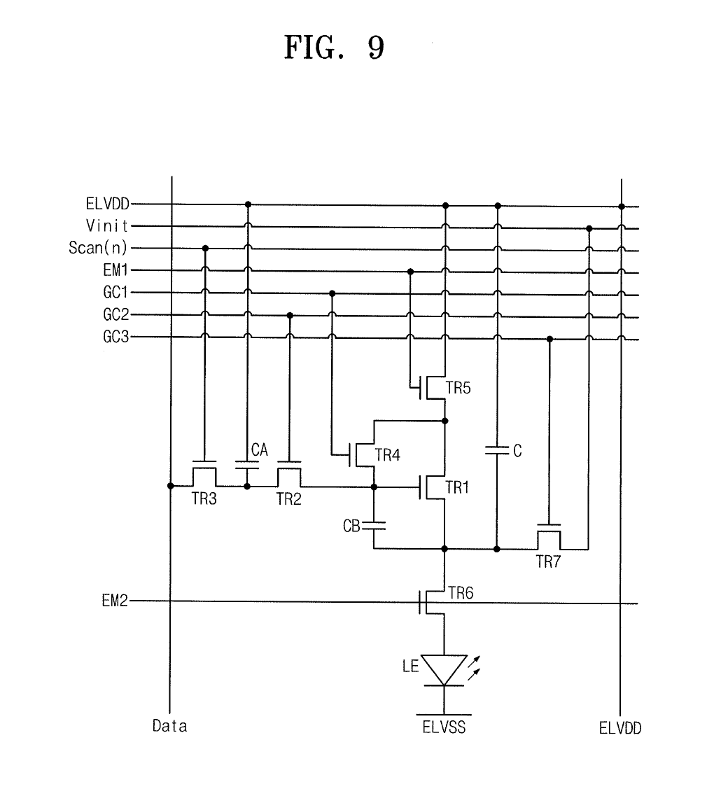

FIG. 9 illustrates another embodiment of a pixel circuit. A difference between the pixel circuits in FIGS. 7 and 9 may be as follows. A third capacitor C is disposed between a signal line to which a first voltage ELVDD is applied and a node connected to the second electrode of seventh transistor TR7, the second electrode of first transistor TR1, the second electrode of first capacitor CB, and the first electrode of sixth transistor TR6.

In one embodiment, a potential difference Vgs between the first and second electrodes of first capacitor CB may be expressed by (α VData−α Vinit+β Vth), where α is CA C/(CA CB+CB C+C CA) and β is (CA CB2+CB C2+CB2 C+CA CB C)/{(CB+C)·(CA CB+CB C+C CA)). The symbols in this expression may otherwise be the same as described with reference to FIGS. 2 and 7.

By way of summation and review, techniques have been developed in the related art in an attempt to compensate for the threshold voltage of the driving transistor of a pixel circuit. According to one technique, compensation of the threshold voltage is performed at the same time as a data programming operation. However, using such a technique makes it difficult to secure sufficient time for compensating the threshold voltage. As a result, brightness spots may be generated on a displayed image.

Also, in case of displaying a three-dimensional image according to the aforementioned technique, the emission time must be shortened to prevent a cross talk between left eye and right eye images. As a result, brightness of the three-dimensional image is lowered.

In accordance with one or more of the aforementioned embodiments, an emission period is elongated because programming is performed during the emission period. Also, the above-described effects increase when different images are supplied to left and right eyes of a user via a shutter device, e.g., when an image display device displays a three-dimensional image.

Also, when displaying a two-dimensional image, a period other than a threshold voltage compensation period and a transfer period may be used as an emission period. Thus, it is possible to reduce brightness of light emission and to increase a lifetime of a light-emitting element. Also, brightness spot may be improved by securing a time for compensating the threshold voltage of the driving transistor.

Also, because capacitors of pixels in which a data voltage is programmed have the same capacitance, it is possible to obtain the same brightness for the same data voltage. Also, first and second capacitors are scaled down because, during an emission period, the first and second capacitors are disconnected and are not connected in series. Also, it is possible to simplify a circuit for control a scan signal Scan(n).

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A method of controlling a pixel circuit, which includes a first transistor to control an amount of current supplied to a light-emitting element corresponding to a voltage retained by a first capacitor connected to a gate electrode of the first transistor, a second transistor to control a connection between the gate electrode of the first transistor and a second capacitor and a connection between the first capacitor and second capacitor, and a third transistor to control a connection between the second capacitor and a data line, the method comprising:
turning on the third transistor while current corresponding to a voltage stored in the first capacitor is supplied to the light-emitting element after the second transistor is turned off; and
turning on the second transistor after the third transistor is turned off.

2. The method as claimed in claim 1, further comprising:
compensating a threshold voltage of the first transistor with respect to a voltage stored in the first capacitor, the compensating performed before the second transistor is turned on after the third transistor is turned off.

3. The method as claimed in claim 1, further comprising:
electrically disconnecting the light-emitting element from the first transistor after the third transistor is turned off.

4. An image display device, comprising:
a control circuit including a first transistor configured to control an amount of current supplied to a light-emitting element based on a voltage stored in a first capacitor connected to a gate electrode of the first transistor;
a second transistor configured to control a connection between the gate electrode of the first transistor and the first capacitor and a connection between the gate electrode of the first transistor and a second capacitor; and
a third transistor configured to control a connection between the second capacitor and a data line, wherein the third transistor is turned on while a current corresponding to the voltage stored in the first capacitor is supplied to the light-emitting element after the second transistor is turned off, and the second transistor is turned on after the third transistor is turned off.

5. The device as claimed in claim 4, wherein:
the third transistor is turned off after a threshold voltage of the first transistor is compensated with respect to the voltage stored in the first capacitor, and
the second transistor is turned on after the third transistor is turned off.

6. A pixel circuit, comprising:
a first transistor coupled to a light emitting element;
a first capacitor coupled to the first transistor;
a second transistor coupled to the first capacitor;
a third transistor coupled between the second transistor and a data line; and
a second capacitor having a first electrode coupled between the second and third transistors, wherein the first transistor controls an amount of current supplied to the light emitting element based on a first data voltage while a second data voltage is stored in the second capacitor, and wherein the first data voltage is stored in the first capacitor.

7. The circuit as claimed in claim 6, wherein:
the first data voltage corresponds to a first frame of image data, and
the second data voltage corresponds to a second frame of image data.

8. The circuit as claimed in claim 6, wherein the first data voltage is stored in the second capacitor before the second data voltage is stored in the second capacitor.

9. The circuit as claimed in claim 8, wherein the first data voltage is transferred from the data line for storage in the second capacitor when the third transistor is on and the second transistor is off.

10. The circuit as claimed in claim 9, wherein the first data voltage is transferred from the second capacitor for storage in the first capacitor when the third transistor is off and the second transistor is on.

11. The circuit as claimed in claim 10, wherein the second data voltage is transferred from the data line to the second capacitor when the third transistor is on, the second transistor is off, and the first data voltage is stored in the first capacitor.

12. The circuit as claimed in claim 6, wherein the first capacitor is coupled between two terminals of the first transistor.

13. The circuit as claimed in claim 6, wherein the second capacitor has a second electrode coupled to a power supply voltage.

14. The circuit as claimed in claim 6, wherein the third transistor is controlled by a scan signal.

15. The circuit as claimed in claim 6, wherein the first capacitor stores a voltage based on an initialization voltage before the first data voltage is stored in the first capacitor.

16. The circuit as claimed in claim 6, further comprising:
a third capacitor having a first electrode coupled to the first transistor and first capacitor and a second electrode coupled between the first transistor and a power supply voltage, wherein the third capacitor stores a voltage based on a threshold voltage of the first transistor before the first data voltage is stored in the first capacitor.

17. A pixel, comprising:
a light emitting element; and
a control circuit to control the light emitting element,
wherein the light emitting element emits light based on a first data voltage while simultaneously storing a second data voltage, and wherein the first data voltage corresponds to a first frame of image data and the second data voltage corresponds to a second frame of image data.

18. The pixel as claimed in claim 17, wherein the control circuit includes:
a first transistor coupled to the light emitting element;
a first capacitor coupled to the first transistor;
a second transistor coupled to the first capacitor; and
a third transistor coupled between the second transistor and a data line; and
a second capacitor having a first electrode coupled between the second and third transistors, wherein the first transistor controls an amount of current supplied to the light emitting element based on the first data voltage while the second data voltage is stored in the second capacitor.

19. The pixel as claimed in claim 18, wherein the first data voltage is stored in the second capacitor before the second data voltage is stored in the second capacitor.

20. The pixel as claimed in claim 19, wherein the first data voltage is transferred from the data line for storage in the second capacitor when the third transistor is on and the second transistor is off.
